(19) United States
(12) Patent Application Publication
(10) Pub. No.: US 2026/0134328 A1
(43) Pub. Date: May 14, 2026

(54) MEMRISTOR-BASED CIRCUIT FOR IMPLEMENTING A QUANTUM ERROR CORRECTION DECODER AND METHODS FOR TRAINING AND INFERENCE OF A MEMRISTOR-BASED QUANTUM ERROR CORRECTION DECODER NEURAL NETWORK

(71) Applicant: IRREVERSIBLE INC., Sherbrooke (CA)

(72) Inventors: Pierre-Antoine Jean Yvon MOUNY, Sherbrooke (CA); Victor Clément YON, Sherbrooke (CA); Sophie ROCHETTE, Sherbrooke (CA); Pooya RONAGH, Guelph (CA); Dominique DROUIN, Sainte-Catherine-de-Hatley (CA); Yann Raymond François BEILLIARD, Sherbrooke (CA); Frédéric MARCOTTE, Trois-Rivières (CA)

(21) Appl. No.: 19/391,308

(22) Filed: Nov. 17, 2025

Related U.S. Application Data
(63) Continuation of application No. PCT/CA2024/050673, filed on May 17, 2024.
(60) Provisional application No. 63/503,098, filed on May 18, 2023.

(51) Int. Cl. G06N 10/70; G06N 3/048; G06N 3/065; G06N 3/08

(52) U.S. Cl. CPC G06N 10/70; G06N 3/048; G06N 3/065; G06N 3/08

(57) ABSTRACT

A memristors-based circuit for implementing a quantum error correction decoder may include a memristor crossbar unit configured for receiving data of quantum measurements from a quantum error correction protocol and for implementing a plurality of tunable parameters of a neural network.

### CROSS-REFERENCE

This application is a continuation of International Application No. PCT/CA2024/050673, filed May 17, 2024, which claims the benefit of U.S. Provisional Application No. 63/503,098, filed May 18, 2023, each of which applications are incorporated herein by reference in their entireties.

### BACKGROUND

Quantum computing promises to revolutionize computational tasks by exploiting quantum phenomena such as superposition and entanglement. Unlocking the full potential of quantum computing requires overcoming challenges for ensuring fault-tolerance against errors inherent in quantum systems. Fault-tolerant quantum computation (FTQC) technology has yet to be developed. While FTQC devices would, in theory, manage the errors that accumulate during computation, finding ways to make the requirements of physical FTQC hardware more feasible will help to bridge the gap between application and hardware development.

Fault-tolerant protocols hold the promise of performing arbitrarily large quantum computation by protecting logical quantum information against noise (Preskill, J., Reliable quantum computers, Proc. Royal Soc. London. Ser. A: Math. Phys. Eng. Sci. 454, 385-410, 1998, which is incorporated herein by reference in its entirety). To this end, a prominent class of quantum error-correction codes are the stabilizer codes (Gottesman, D., Class of quantum error-correcting codes saturating the quantum hamming bound, Phys. Rev. A 54, 1862-1868, 1996, which is incorporated herein by reference in its entirety). The performance of stabilizer codes has culminated with the introduction of topological methods to detect errors on a qubit lattice (Kitaev, A., Fault-tolerant quantum computation by anyons, Annals Phys. 303, 2-302003, which is incorporated herein by reference in its entirety). Surface error-correction code has emerged as a solution for practical fault-tolerant quantum computing (Fowler, A. G. et al., Surface codes: Towards practical large-scale quantum computation, Phys. Rev. A 86, 032324, 2012, which is incorporated herein by reference in its entirety), where one can copy the eigenvalue added by an environment interaction to a physical qubit into an ancilla qubit. In such cases, measuring stabilizer operators to detect errors may be reduced to measuring ancillas without collapsing the physical qubits. The measured eigenvalues of stabilizer operators are used to build syndromes, i.e., strings of classical bits. Decoding a syndrome is the task of finding an appropriate recovery operator such that the logical qubit recovers its state before the environment interaction.

Finding good and efficient quantum error correction decoders remains an open problem. Neural networks have been studied to this end (Varsamopoulos, S. et al., Decoding small surface codes with feedforward neural networks, Quantum Sci. Technol. 3, 015004, 2017: Chamberland, C. & Ronagh, P., Deep neural decoders for near term fault-tolerant experiments, Quantum Sci. Technol. 3, 044002, 2018: Chinni, C. et al., Neural Decoder for Topological Codes using Pseudo—Inverse of Parity Check Matrix, 2019 IEEE Information Theory Workshop (ITW), Visby, Sweden, pp. 1-5, 2019: Nikolas P. Breuckmann and Xiaotong Ni, Scalable Neural Network Decoders for Higher Dimensional Quantum Codes, Quantum 2, 68, 2018, each of which is incorporated herein by reference in its entirety), and can outperform state-of-the-art decoding algorithms such as minimum-weight perfect matching (MWPM) (Dennis, E. et al., Topological quantum memory, J. Math. Phys. 43, 4452-4505, 2002, which is incorporated herein by reference in its entirety) in terms of accuracy threshold (Krastanov, S. & Jiang, L., Deep Neural Network Probabilistic Decoder for Stabilizer Codes, Sci. Reports 7, 11003, 2017: Baireuther, P. et al., Machine-learning-assisted correction of correlated qubit errors in a topological code, Quantum 2, 48, 2018: Maskara, N. et al., Advantages of versatile neural-network decoding for topological codes, Phys. Rev. A 99, 052351, 2019, which is incorporated herein by reference in its entirety). Among different network architectures, recurrent neural networks (RNN) have an ability to treat decoding as a sequential classification problem, i.e., decode a sequence of error correction rounds of arbitrary length (Baireuther, P. et al., Neural network decoder for topological color codes with circuit level noise, New J. Phys. 21, 013003, 2019: Varsamopoulos, S. et al., Comparing Neural Network Based Decoders for the Surface Code, IEEE Transactions on Comput. 69, 300-311, 2020, which is incorporated herein by reference in its entirety).

### SUMMARY

An implementation of a neural network quantum error correction decoders may comply with various parameters for accurate quantum error correction. It may be desirable that a quantum error correction decoder hardware provide a fast inference time to keep up with the rate of syndrome generation, and that a low thermal dissipation be compatible with cryogenic co-integration with the quantum processor, to be capable to reduce any added delay due to signals routing in-and-out of the cryostat, and to avoid a wiring bottleneck. In the case of digital neural networks, inference time may be limited by clocking of the processing unit, and power consumption is dominated by the number of multiply-and-accumulate (MAC) operations. Therefore, hardware for fast and low-power neural quantum error correction decoders may be required.

One promising avenue is resistive memory devices, which may provide the two features of the fast inference and the low energy consumption (Wang, P. et al. Cryogenic Benchmarks of Embedded Memory Technologies for Recurrent Neural Network based Quantum Error Correction, In 2020 IEEE International Electron Devices Meeting (IEDM), 38.5.1-38.5.4, 2020: Ichikawa, Y. et al., Non-volatile Memory Application to Quantum Error Correction with Non-uniformly Quantized CiM, 2022 IEEE International Memory Workshop, 1-4, 2022, which is incorporated herein by reference in its entirety). In such a hardware implementation, the neural network tunable parameters are programmed in the conductance states of memristors arranged in crossbars. Focusing on how specifically to build such a neural quantum error correction decoder using memristor crossbars to ensure accuracy of the quantum error correction decoder, sufficient speed of the decoding task, and low enough power dissipation to permit co-integration with quantum processors in a cryogenic environment may be advantageous.

The present disclosure provides a memristors-based circuit for implementing a quantum error correction decoder and methods for training and inference of a memristor-based quantum error correction decoder neural network. The present disclosure may improve upon existing quantum error correction decoders in at least some aspects by using memristor crossbars and analog electronic components to accelerate the decoding task and/or dissipate less energy.

A memristors-based decoder circuit and methods of the present disclosure may provide at least some of the following advantages. The memristor-based decoder may reduce processing time compared to other types of decoders, in particular, to other hardware implementations of neural quantum error correction decoders. It may compute the neural network inference with low power dissipation. It may be implemented on hardware which may be placed and operated in the dilution refrigerator or another cryogenic cooling device. The training methods that may be applied to this memristor-based decoder circuit may take into account specific characteristics of the memristor-based circuit and its components resulting in a high decoding performance even with imperfect hardware. The memristor-based circuit is reprogrammable and may be adapted to represent various neural network models corresponding to different use cases.

In an aspect, the present disclosure provides a memristors-based circuit for implementing a quantum error correction decoder. The circuit comprises a memristor crossbar unit configured for receiving data of quantum measurements from a quantum error correction protocol and for implementing a plurality of tunable parameters of a neural network.

In some embodiments, the memristors-based circuit further comprises a first activation function unit operatively coupled to said memristor crossbar unit, the first activation function unit is configured for implementing an activation function layer of the neural network. In some embodiments, the memristors-based circuit further comprises a second memristor crossbar unit operatively coupled to the first activation function unit, the second memristor crossbar unit configured for implementing a plurality of tunable parameters of the neural network. In some embodiments, the memristors-based circuit further comprises a second activation function unit operatively coupled to the second memristor crossbar unit, the second activation function unit is configured for implementing an activation function output layer of said neural network. In some embodiments, the memristors-based circuit comprises two or more first memristor crossbar units and two or more first activation function units.

In some embodiments, the memristors-based circuit further comprises a recurrence unit operatively coupled to the memristor crossbar unit and to the first activation function unit, the recurrence unit is for directing the first activation function unit results to the memristor crossbar unit. In some embodiments, the recurrence unit comprises one or more digital units. In some embodiments, the one or more digital units comprise at least one member of the group consisting of a flip-flop, a microprocessor, a digital memory, a graphical processing unit (GPU), a central processing unit (CPU), a field programmable gate array (FPGA), a digital application specific integrated circuits (digital ASIC), an analog-to-digital converter (ADC), a digital-to-analog converter (DAC), and a digital delay line. In some embodiments, the recurrence unit comprises one or more analog units. In some embodiments, the one or more analog units comprise at least one member of the group consisting of a memristor, an operational amplifier circuit, a diode, a transistor, a resistor, a capacitor, an inductor, an analog switched capacitor circuit, and an analog passive delay line.

In some embodiments, the results of inference on the neural network are used for constructing at least one recovery operation for quantum error correction.

In some embodiments, the first and second activation function units comprise at least one member of the group consisting of: a non-linear function, ReLU, leaky ReLU, exponential linear unit, softplus, sigmoid, tanh, softmax, and hard ReLU.

In some embodiments, at least one of the first and second activation function unit is a digital unit. In some embodiments, the digital unit comprises at least one member of the group consisting of a flip-flop, a microprocessor, a digital memory, a graphical processing unit (GPU), a central processing unit (CPU), a field programmable gate array (FPGA), and a digital application specific integrated circuit (digital ASIC). In some embodiments, at least one of the first and second activation function unit is an analog unit. In some embodiments, the analog unit comprises at least one member of the group consisting of a memristor, an operational amplifier circuit, a diode, a transistor, a resistor, a capacitor, and an inductor.

In some embodiments, the memristors-based circuit further comprises a preprocessing unit for converting quantum measurements into input signals for said memristor crossbar unit.

In some embodiments, the memristors-based circuit further comprises a postprocessing unit for converting results of inference on said neural network into control signals for said quantum error correction protocol.

In some embodiments, the memristors-based circuit is used in ensemble with a global decoder within a multi-stage decoding architecture.

In some embodiments, the memristors-based circuit is coupled to a cryogenic device having different cryogenic stages.

In an aspect, the present disclosure provides a method for inference of a memristors-based quantum error correction decoder neural network. The method comprises (a) providing data of quantum measurements of a quantum error correction code syndrome qudits to a memristor crossbar unit of a quantum error correction decoder neural network implemented on a memristors-based circuit; (b) using the memristor crossbar unit to process the data of quantum measurements by vector matrix multiplication operation; and (c) providing results to generate a local partial recovery operation.

In some embodiments, the method further comprises (i) applying a first activation function to the processed data of quantum measurements; (ii) directing results to a second memristor crossbar unit of the quantum error correction decoder neural network; (iii) using the second memristor crossbar unit to process the results by vector matrix multiplication operation (iv) and applying a second activation function to the output of the second memristor crossbar unit. In some embodiments, the method further comprises repeating (b) and (i) one or more times wherein the results of (i) are directed to the memristor crossbar unit using a recurrence unit.

In an aspect, the present disclosure provides a method for training a memristors-based quantum error correction decoder neural network. The method comprises at each training step amending a plurality of the quantum error correction decoder neural network tunable parameters based on characteristics of a memristor crossbar. In some embodiments, the characteristics are obtained empirically.

In some embodiments, the characteristics of the memristor crossbar comprises at least one of: programming error of the memristor conductance of said memristor crossbar, readout variability of the memristor conductance of said memristor crossbar, rate of stuck-at-fault memristors of said memristor crossbar, the conductance drift in time of the memristor conductance states, the minimal and maximal conductance value of each memristor, the resistance of the crossbar interconnections, and specific location of stuck-at-fault memristors within said memristor crossbar.

In some embodiments, the amending of the plurality of the quantum error correction decoder neural network tunable parameters comprises adding a deviation sampled from a probability distribution corresponding to the programming and readout variability of the memristor conductance to the tunable parameter values.

In some embodiments, the amending of the plurality of the quantum error correction decoder neural network tunable parameters comprises for the tunable parameters corresponding to the stuck-at-fault memristors identified empirically updating the tunable parameters to the stuck-at-fault memristors values.

In some embodiments, the amending of the plurality of the quantum error correction decoder neural network tunable parameters comprises updating random tunable parameters to the stuck-at-fault memristors values according to a probability corresponding to the empirically measured proportion of stuck-at-fault memristors in the memristor crossbar.

In some embodiments, the amending of the plurality of the quantum error correction decoder neural network tunable parameters takes into account characteristics of the memristor-based circuit, wherein the characteristics comprises at least one member of the group consisting of precision of digital-to-analog conversions, precision of analog-to-digital conversions, and deformation of the signals through the CMOS components.

In an aspect, the present disclosure provides a method for programming the memristor crossbar. The method comprises setting conductance state for each memristor in the memristor crossbar according to the trained tunable parameter.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1A is a diagram of an example of a memristors-based circuit for implementing a quantum error correction decoder.

FIG. 1B is a diagram of an example neural network architecture corresponding to the quantum error correction decoder disclosed with respect to FIG. 1A.

FIG. 2 is a flowchart of an example method for inference of a memristors-based quantum error correction decoder neural network.

FIG. 3A is a diagram of an example of a memristor-based circuit for vector matrix multiplication.

FIG. 3B is a diagram of an example neural network architecture corresponding to the memristor-based circuit disclosed with respect to FIG. 3A.

### DETAILED DESCRIPTION

While various embodiments of the invention are shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Neither the Title nor the Abstract is to be taken as limiting in any way the scope of the disclosed invention(s). The title of the present application and headings of sections provided in the present application are for convenience only and are not to be taken as limiting the disclosure in any way.

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

The term “plurality” generally refers to “two or more,” unless expressly specified otherwise.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Where values are described as ranges, the disclosure includes the disclosure of all possible sub-ranges within such ranges, as well as specific numerical values that fall within such ranges irrespective of whether a specific numerical value or specific sub-range is expressly stated.

Certain inventive embodiments herein contemplate numerical ranges. When ranges are present, the ranges include the range endpoints. Additionally, every sub range and value within the range is present as if explicitly written out.

The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

As used herein, the term “classical,” as used in the context of computing or computation, generally refers to computation performed using binary values using discrete bits without use of quantum mechanical superposition and quantum mechanical entanglement. A classical computer may be a digital computer, such as a computer employing discrete bits (e.g., 0's and 1's) without use of quantum mechanical superposition and quantum mechanical entanglement.

As used herein, the term “non-classical,” as used in the context of computing or computation, generally refers to any method or system for performing computational procedures outside of the paradigm of classical computing.

The term “quantum computing” generally refers to a method of computing which utilizes the concept of quantum superposition and entanglement to manipulate information, instead of the 0 and 1 binary bits in classical computers. Quantum entanglement generally refers to the phenomenon in which, when multiple qubits interact with each other, their quantum states are “entangled” and may no longer be represented individually. Quantum superposition generally refers to the principle which states that the quantum state of a qubit can be represented by adding together two or more different quantum states, each associated with a probability. In some cases, the probabilities of all states add to 1. Quantum circuits, consisting of one or more quantum gates, may be designed to perform quantum computation, such as factoring large prime numbers, which may be infeasible or highly inefficient for classical computers. The term “quantum gates” generally refers to logical operators comprising one or multiple qubits, which can be used to perform logical operations.

As used herein, the term “quantum device” generally refers to any device or system for performing computations using any quantum mechanical phenomenon such as quantum mechanical superposition or quantum mechanical entanglement.

As used herein, the terms “quantum computation,” “quantum procedure,” “quantum operation,” and “quantum computer” generally refer to any method or system for performing computations using quantum mechanical operations (such as unitary transformations or completely positive trace-preserving (CPTP) maps on quantum channels) on a Hilbert space represented by a quantum device.

As used herein, the term “qubit” generally refers to a unit of quantum information processing whose quantum state is a complex unit vector of dimension 2. These two dimensions are typically referred to as “0” and “1”. When quantum error correction is used, a logical qubit refers to a set of physical qubits that encodes one fault-tolerant qubit.

As used herein, the term “qudit” generally refers to a fundamental quantum device with two or more different quantum states.

As used herein, the term “physical qubit” generally refers to a physical implementation of a qubit.

As used herein, the term “physical qudit” generally refers to a physical implementation of a qudit.

As used herein, the term “logical qubit” generally refers to the abstract concept of a qubit, which may be realized by one or more physical qubits. It is to be understood that the logical qubits form an abstract Hilbert space used for quantum information processing (e.g., quantum computation); that the logical qubits are encoded using various degrees of freedom of the physical qubits; that the physical Hilbert space associated to the physical qubits is often of much higher dimension than the logical Hilbert space and therefore allows the physical qubits to protect the logical qubits against various sources of error.

As used herein, the term “logical qudit” generally refers to the abstract concept of a qudit, which may be realized by one or more physical qudits.

A collection of n qubits has its “quantum state” in the Hilbert space which is the tensor product of the Hilbert spaces of the individual qubits.

As used herein, the term “quantum gate” generally refers to a unitary operation performed on the collective quantum state of one or more qubits or qudits.

As used herein, the term “Pauli gate” generally refers to one of the Pauli quantum logic gates X, Y or Z.

The existing neural network quantum error correction decoders and methods of training and inference using thereof may have at least some drawbacks. The aforementioned decoders may be implemented on a digital representation, for example the model may be built on a classical computer outside of the cryogenic device inside of which lays the quantum device which implements the quantum error correction code. This can result in delay between the syndrome extraction and syndrome processing by the decoder since syndrome signals have to travel out of the cryogenic device. This approach can also cause issues of scalability, i.e., as the size of the quantum processor grows, there is an increasingly larger number of wires that may need to send signals from the cryogenic device to the decoder located outside of it. This is known as the wiring bottleneck challenge.

Recognized herein is the need for improved methods and systems that may overcome at least one of the above-identified drawbacks.

### Classical Computer/Digital Computer

In some cases, the systems, media, networks, and methods described herein comprise a classical computer (e.g., a digital computer), or use of the same. In some cases, a classical computer may comprise a digital computer. In some cases, the classical computer includes one or more hardware central processing units (CPUs) that carry out the classical computer's functions. In some cases, the classical computer further comprises an operating system (OS) configured to perform executable instructions. In some cases, the classical computer is connected to a computer network. In some cases, the classical computer is connected to the Internet such that it accesses the World Wide Web.

In some cases, the classical computer is connected to one or more computer servers, which can enable distributed computing, such as a cloud computing infrastructure. In some cases, the classical computer is connected to an intranet and/or extranet or an intranet and/or extranet that is in communication with the Internet. In some cases, the classical computer is connected to a data storage device. In some cases, the network is a telecommunication and/or data network. In some cases, the network is a peer-to-peer network, which may enable devices coupled to the computer system to behave as a client or a server.

In accordance with the description herein, suitable classical computers may include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Smartphones may be suitable for use with methods and systems described herein. Select televisions, video players, and digital music players, in some cases, with computer network connectivity, may be suitable for use in the systems and methods described herein. Suitable tablet computers may include those with booklet, slate, and convertible configurations.

In some cases, the classical computer includes an operating system configured to perform executable instructions. The operating system may be, for example, software, including programs and data, which manages the device's hardware and provides services for execution of applications. Suitable server operating systems include, by way of non-limiting examples, FreeBSD, OpenBSD, NetBSD®, Linux®, Apple® Mac OS X Server®, Oracle® Solaris®, Windows Server®, and Novell® NetWare®. Suitable personal computer operating systems may include, by way of non-limiting examples, Microsoft® Windows®, Apple® Mac OS X®, Apple® macOS®, UNIX®, and UNIX-like operating systems such as GNU/Linux®. In some cases, the operating system is provided by cloud computing. Suitable mobile smart phone operating systems may include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Suitable media streaming device operating systems may include, by way of non-limiting examples, Apple TV®, Roku®, Boxee®, Google TV®, Google Chromecast®, Amazon Fire®, and Samsung® HomeSync®. Suitable video game console operating systems may include, by way of non-limiting examples, Sony® PS3®, Sony® PS4®, Microsoft® Xbox 360®, Microsoft® Xbox One®, Nintendo® Wii®, Nintendo® Wii U®, and Ouya®.

In some cases, the classical computer includes a storage and/or memory device. In some cases, the storage and/or memory device is one or more physical apparatuses used to store data or programs on a temporary or permanent basis. In some cases, the storage and/or memory device may have one or more additional data storage units that are external to the classical computer, for example, being located on a remote server that is in communication with the classical computer through an intranet or the Internet. In some cases, the device comprises a volatile memory and uses power to maintain stored information. In some cases, the device comprises a non-volatile memory and retains stored information when the classical computer is not powered. In some cases, the non-volatile memory comprises flash memory. In some cases, the non-volatile memory comprises dynamic random-access memory (DRAM). In some cases, the non-volatile memory comprises ferroelectric random-access memory (FRAM). In some cases, the non-volatile memory comprises phase-change random access memory (PRAM). In some cases, the non-volatile memory comprises resistive random-access memory (RRAM). In some cases, the device comprises a storage device including, by way of non-limiting examples, CD-ROMs, DVDs, flash memory devices, magnetic disk drives, magnetic tapes drives, optical disk drives, and cloud computing based storage. In some cases, the storage and/or memory device is a combination of devices such as those disclosed herein.

In some cases, the classical computer includes a display to send visual information to a user. In some cases, the display is a cathode ray tube (CRT). In some cases, the display is a liquid crystal display (LCD). In some cases, the display is a thin film transistor liquid crystal display (TFT-LCD). In some cases, the display is an organic light emitting diode (OLED) display. In some cases, on OLED display is a passive-matrix OLED (PMOLED) or active-matrix OLED (AMOLED) display. In some cases, the display is a plasma display. In some cases, the display is a video projector. In some cases, the display is a combination of devices such as those disclosed herein.

In some cases, the classical computer includes an input device to receive information from a user. In some cases, the input device is a keyboard. In some cases, the input device is a pointing device including, by way of non-limiting examples, a mouse, trackball, track pad, joystick, game controller, or stylus. In some cases, the input device is a touch screen or a multi-touch screen. In some cases, the input device is a microphone to capture voice or other sound input. In some cases, the input device is a video camera or other sensor to capture motion or visual input. In some cases, the input device is a Kinect®, Leap Motion®, or the like. In some cases, the input device is a combination of devices such as those disclosed herein. In some cases, the input device may comprise augmented reality or virtual reality devices including Meta Quest® series, Oculus Rift® series, or the like.

### Multi-Level Quantum System

A multi-level quantum system may be structured in a way which operates based on quantum mechanical processes such as superposition and entanglement of quantum states. A multi-level system may include a system with two or more energy states of an artificial or natural atom, for example, the ground state (|0>) and first excited state (|1>) of a superconducting artificial atom. Such a multi-level system can have 0, 1, . . . , n energy states. A multi-level quantum system may be referred to as a “qudit” and multiple qudits may be used to implement a quantum computing system. A qudit may be thought of as one of n quantum states 0,1, . . . , n−1 or a superposition of any of the n states. Specific subcategories of qudits exist, including a system consisting of only two energy states, the ground state (|0>) and first excited state (|1>). These two-state systems are referred to as “qubits”. Each qubit can be placed in one of these two states. However, due to the nature of multi-level quantum systems, they can also be placed in a superposition of these two states. Entangled qubits or qudits can perform computational tasks.

Herein, when referring to “qubits” it should be assumed that what is described may also refer to “qudits,” and vice versa.

### Quantum Device/Quantum Hardware

Any type of quantum hardware may be suitable for the technologies disclosed herein. A quantum processor or quantum computer may comprise one or more adiabatic quantum computers, quantum gate arrays, one-way quantum computers, topological quantum computers, quantum Turing machines, superconductor-based quantum computers, trapped ion quantum computers, trapped atom quantum computers, optical lattices, quantum dot computers, spin-based quantum computers, spatial-based quantum computers, Loss-Di Vincenzo quantum computers, nuclear magnetic resonance (NMR) based quantum computers, solution-state NMR quantum computers, solid-state NMR quantum computers, solid-state NMR Kane quantum computers, electrons-on-helium quantum computers, cavity-quantum-electrodynamics based quantum computers, molecular magnet quantum computers, fullerene-based quantum computers, linear optical quantum computers, diamond-based quantum computers, nitrogen-vacancy (NV) diamond-based quantum computers, Bose-Einstein condensate-based quantum computers, transistor-based quantum computers, and rare-earth-metal-ion-doped inorganic crystal based quantum computers. The quantum processor or quantum computer may comprise one or more of: quantum annealers, Ising solvers, optical parametric oscillators (OPO), and gate model quantum computers.

A quantum processor or quantum computer may comprise one or more qubits. The one or more qubits may comprise superconducting qubits, trapped ion qubits, trapped atom qubits, photon qubits, quantum dot qubits, electron spin-based qubits, nuclear spin-based qubits, molecular magnet qubits, fullerene-based qubits, diamond-based qubits, nitrogen-vacancy (NV) diamond-based qubits, Bose-Einstein condensate-based qubits, transistor-based qubits, or rare-earth-metal-ion-doped inorganic crystal based qubits.

In some cases, a quantum device with a limitation of a two-dimensional structure of a quantum chip or a limitation on how many neighbouring qubits each qubit is connected to may benefit from methods and systems disclosed herein. In accordance with the description herein, suitable quantum computers may include, by way of non-limiting examples including the associated references, each of which is incorporated herein by reference in its entireties: superconducting quantum computers (qubits implemented as small superconducting circuits-Josephson junctions) (Clarke et al., “Superconducting quantum bits”, Nature 453, no. 7198, pp. 1031-1042, 2008); trapped-ion quantum computers (qubits implemented as states of trapped ions) (Kielpinski et al., “Architecture for a large-scale ion-trap quantum computer”, Nature 417, no. 6890, pp. 709-711, 2002); optical lattice quantum computers (qubits implemented as states of neutral atoms trapped in an optical lattice) (Deutsch et al., “Quantum computing with neutral atoms in an optical lattice”, Fortschritte der Physik: Progress of Physics 48, no. 9-11, pp. 925-943. 2000); spin-based quantum dot computers (qubits implemented as the spin states of trapped electrons) (Imamoğlu et al., “Quantum information processing using quantum dot spins and cavity QED”, Physical Review Letters 83, no. 20, p. 4204, 1999); spatial-based quantum dot computers (qubits implemented as electron positions in a double quantum dot) (Fedichkin et al., “Novel coherent quantum bit using spatial quantization levels in semiconductor quantum dot”, arXiv: quant-ph/0006097, 2000); coupled quantum wires (qubits implemented as pairs of quantum wires coupled by quantum point contact) (Bertoni et al., “Quantum logic gates based on coherent electron transport in quantumz wires”, Physical Review Letters 84, no. 25, p. 5912, 2000); nuclear magnetic resonance quantum computers (qubits implemented as nuclear spins and probed by radio waves) (Cory et al., “Nuclear magnetic resonance spectroscopy: An experimentally accessible paradigm for quantum computing”, arXiv: quant-ph/9709001, 1997); solid-state NMR Kane quantum computers (qubits implemented as the nuclear spin states of phosphorus donors in silicon) (Kane, “A silicon-based nuclear spin quantum computer”, Nature 393, no. 6681, pp. 133-137, 1998); electrons-on-helium quantum computers (qubits implemented as electron spins) (Lyon, “Spin-based quantum computing using electrons on liquid helium”, arXiv: cond-mat/0301581, 2006); cavity quantum electrodynamics-based quantum computers (qubits implemented as states of trapped atoms coupled to high-finesse cavities) (Burell, “An Introduction to Quantum Computing using Cavity QED concepts,” arXiv: 1210.6512, 2012); molecular magnet-based quantum computers (qubits implemented as spin states) (Leuenberger et al., “Quantum Computing in Molecular Magnets”, arXiv: cond-mat/0011415, 2001); fullerene-based electron spin resonance (ESR) quantum computers (qubits implemented as electronic spins of atoms or molecules encased in fullerenes) (Harneit, “Quantum Computing with Endohedral Fullerenes”, arXiv: 1708.09298, 2017); linear optical quantum computers (qubits implemented as processing states of different modes of light through linear optical elements such as mirrors, beam splitters and phase shifters) (Knill et al. “Efficient linear optics quantum computation”, arXiv: quant-ph/0006088, 2000); diamond-based quantum computers (qubits implemented as electronic or nuclear spins of nitrogen-vacancy (NV) centres in diamond) (Nizovtsev et al., “A quantum computer based on NV centers in diamond: optically detected nutations of single electron and nuclear spins”, Optics and spectroscopy 99, no. 2, pp. 233-244, 2005); Bose-Einstein condensate-based quantum computers (qubits implemented as two-component Bose-Einstein condensates) (Byrnes et al., “Macroscopic quantum computation using Bose-Einstein condensates”, arXiv: quantum-ph/1103.5512, 2011); transistor-based quantum computers (qubits implemented as semiconductors coupled to nanophotonic cavities) (Sun et al., “A single-photon switch and transistor enabled by a solid-state quantum memory”, arXiv: quant-ph/1805.01964, 2018); rare-earth-metal-ion-doped inorganic crystal-based quantum computers (qubits implemented as atomic ground state hyperfine levels in rare-earth-ion-doped inorganic crystals) (Ohlsson et al. “Quantum computer hardware based on rare-earth-ion-doped inorganic crystals”, Optics Communications 201, no. 1-3, pp. 71-77, 2002); metal-like carbon nanospheres based quantum computers (qubits implemented as electron spins in conducting carbon nanospheres) (Náfrádi et al., “Room temperature manipulation of long lifetime spins in metallic-like carbon nanospheres”, arXiv: cond-mat/1611.07690, 2016); topological quantum computers (qubits implemented as non-Abelian anyons) (Nayak et al., “Non-Abelian Anyons and Topological Quantum Computation,” arXiv: 0707.1889, 2007); photonic continuous-variable quantum computing hardware (quantum variables represented by the quadrature operators of the quantum harmonic oscillators in a quantum optical mode) (Arrazola et al., “Quantum circuits with many photons on a programmable nanophotonic chip,” Nature 591, pp. 54-60, 2021); photonic qubit-based quantum hardware (qubits implemented on pairs of optical paths) (O'Brien et al., “Photonic quantum technologies,” Nature Photonics 3, pp. 687-695, 2009); quantum computing hardware based on bosonic codes (error-protected qubits are formed by embedding a finite-dimensional code space within the infinite-dimensional Fock space associated with a bosonic quantum field mode; examples include the Gottesman-Kitaev-Preskill (GKP) code, cat codes, and binomial codes, respectively) (Gottesman et al., “Encoding a qubit in an oscillator,” Physical Review A 64, 012310, 2001; Chamberland et al., “Building a Fault-Tolerant Quantum Computer Using Concatenated Cat Codes,” PRX Quantum 3, 010329, 2022; Michael et al., “New Class of Quantum Error-Correcting Codes for a Bosonic Mode,” Physical Review X 6, 031006, 2016); quantum hardware based on coherent network computing (operating by sampling low-energy eigenstates of an Ising Hamiltonian by encoding the spins in a network of optical parametric oscillators with all-to-all connectivity; future architectures may exploit quantum entanglement for computation) (Inui et al., “Entanglement and quantum discord in optically coupled coherent Ising machines,” Physical Review A 102, 062419, 2020; and Yanagimoto et al., “Embedding entanglement generation within a measurement-feedback coherent Ising machine,” arXiv: 1906.04902, 2019).

### Quantum Error Correcting Codes

A quantum error correcting code (QECC) may be implemented by constructing one or more working logical qudits with a relatively low error rate from several physical data qudits with a relatively higher error rate. A QECC may be characterized by several parameters, including, for example, the number of data qudits (denoted by n), the number of logical qudits (denoted by k), and the number of errors which may occur to a code state and still be corrected (called the code distance and denoted by d).

In some implementations, QECCs may be constructed as a natural extension of the classical error correcting codes (ECCs), which can encode one or more logical bits using many low-fidelity bits by correcting bit-flip errors.

A commonly used class of QECCs is stabilizer codes. The general stabilizer formalism may be given as follows. An abelian subgroup K of the n-qudit Pauli group is chosen. This is called the stabilizer subgroup. A set of generators A₁, A₂, . . . , Aₘ is chosen for K. The code space is the space of states of the data qudits which are stabilized by A, that is, eigenstates with an eigenvalue of +1. The code space therefore encodes n-m logical qudits. Simultaneously measuring each of the stabilizers A₁, A₂, . . . , Aₘ projects the data state to the code space. Details may be found in Gheorghiu, “Standard Form of Qudit Stabilizer Groups,” arXiv: 1101.1519, 2011 and Gottesman, “An Introduction to Quantum Error Correction and Fault-Tolerant Quantum Computation,” arXiv: 0904.2557, 2009, each of which is incorporated herein by reference in its entirety.

One example of stabilizer codes is CSS codes. CSS codes are defined using the Calderbank-Shor-Steane (CSS) construction, which produces a single QECC from two nested linear ECCs, C′<C, with the same number of data bits. The logical qubit is encoded within the subquotient C/C′. The reason this construction produces a QECC is that (1) the ability to correct both Pauli-X (bit-flip) errors and Pauli-Z (phase-flip) errors enables full quantum error correction, and (2) application of the Hadamard gate flips a code to its dual, and interchanges X errors for Z errors. For CSS codes, each stabilizer generator is either a Z-type generator or an X-type generator. (Calderbank et al., “Good quantum error-correcting codes exist,” Physical Review A 54, p. 1096, 1996; Steane, “Error Correcting Codes in Quantum Theory,” Physical Review Letters 77, p. 793, 1996; and Chapter 10 of Nielsen et al., “Quantum Computation and Quantum Information”, 10th Anniversary Edition, ISBN 978-1-107-00217-3, Cambridge University Press, 2010; each of which is incorporated herein by reference in its entirety.)

The full quantum error correction procedure can be implemented as follows. At regular time intervals, syndrome extraction circuits comprising data qudits and syndrome qudits are executed. Such a syndrome extraction circuit operates a sequence of physical qudit gates and performs a “stabilizer measurement” to produce readouts from the syndrome qudits. This collection of readouts is referred to as a “syndrome”. This syndrome data provides incomplete information about the error that has occurred and the information is sent to the classical decoder, which infers the most likely error which caused that syndrome. The decoder returns a candidate recovery operation, which is then applied to the data qudits.

Various classical algorithms have been developed to perform efficient and accurate decoding, depending on the one or more error correcting codes used. Some examples and their implementation details can be found in Chamberland et. al., “Triangular color codes on trivalent graphs with flag qubits,” arXiv: 1911.00355, 2020; Kubica et al., “Efficient color code decoders in d≥2 dimensions from toric code decoders,” arXiv: 1905.07393v1, 2019; Delfosse et al., “Almost-linear time decoding algorithm for topological codes,” arXiv: 1709.06218v1, 2017; and Brown et al., “Fault-tolerant error correction with the gauge color code,” arXiv: 1503.08217v1, 2015; each of which is incorporated herein by reference in its entirety.

In some implementations, an algorithm may be performed on a special-purpose classical decoder which is external to the quantum processor. For example, the special-purpose decoder may operate at a sufficiently low cryogenic temperature and may be placed in the physical proximity of the quantum processor at a desired low cryogenic temperature enabling communication lag minimization. As a specific example, the special-purpose decoder may be placed at a suitable cryogenic temperature in the range of a few millikelvins (mK) to several kelvins (K), such as 10 mK, 100 mK, 600 mK, 3 K, or 4 K, and the cryogenic temperature of the quantum processor may be at a few mK or a few tens of mK.

More details on quantum error correction techniques can be found in Devitt et al., “Quantum Error Correction for Beginners,” arXiv: 0905.2794, 2013 and Chapter 10 of Nielsen et al., “Quantum Computation and Quantum Information,” 10th Anniversary Edition, ISBN 978-1-107-00217-3, Cambridge University Press, 2010, each of which is incorporated herein by reference in its entirety.

A topological error correcting code is a stabilizer code where the qudits obey a fixed physical layout, and the logical qudit space is identified with the second homology group of the surface containing the qudits. In this situation, each stabilizer generator corresponds to a two-dimensional face on the surface, forming a plaquette.

### Fault Tolerant Quantum Computation/Fault-Tolerant Quantum Computer

A quantum computing device and its operations may be characterized by its logical and physical components. The physical components of the device are the actual hardware which include qubits, gates, etc., whereas the logical components represent logical functions of the device such as the logical qubits, gates, etc. and refer to the abstract information which is manipulated in the computation performed on the device. As previously mentioned, in various implementations, the construction of one logical qubit according to a QECC may use multiple physical qubits and physical gates. Logical qubits offer longer coherence times and lower error rates compared to individual physical qubits, facilitating FTQC.

Gate-model quantum computation may involve not just logical qubits, but logical components such as qubit preparation, quantum gates, qubit measurement, and waiting (preserving the state of the qubit), which all act on the logical state. Any of these components may fail in operation and may introduce errors into the physical state. In the circumstances where the number of errors introduced is too large so that such errors in the physical state may no longer be corrected by the QECC, the logical state may be erroneous as well.

FTQC may refer to a protocol which implements all these components in a way that is resistant to errors, i.e., the logical outcome of the quantum computation can be made the same as if no failures occurred, provided that the number of errors introduced is not too large beyond the error correction capacity of the device. Some information on fault-tolerant quantum computation can be found in “An Introduction to Quantum Error Correction and Fault-Tolerant Quantum Computation” by Gottesman, D.; https://arxiv.org/pdf/0904.2557.pdf (2009). Fault-tolerance can be essential to useful quantum computing, and building a fault-tolerant device is desirable in constructing a practical quantum computing system. To achieve fault-tolerant quantum computation, an error correction gadget or module may be used to produce a single fault-tolerant logical qubit, and based on this, fault-tolerant gadgets or modules may be provided to correspond to the other components of a quantum circuit such as fault-tolerant preparation, fault-tolerant gates, etc. Multiple schemes for FTQC have been proposed, which use quantum error correcting codes in various ways. Constructing and using fault-tolerant gadgets in the case where each logical qubit is itself encoded in a QECC presents architectural challenges. Further details may be found in “A Game of Surface Codes: Large-Scale Quantum Computing with Lattice Surgery” by Litinski, D., https://arxiv.org/pdf/1808.02892.pdf (2019); “Surface code quantum computing by lattice surgery” by Horsman, C. et al, https://arxiv.org/pdf/1111.4022.pdf (2013); “Fault-tolerant quantum computing with color codes” by Landahl, A. J., Anderson, J. T., Rice, P. R., https://arxiv.org/pdf/1108.5738.pdf (2011); and “Surface codes: Towards practical large-scale quantum computation” by Fowler, A. et al, https://arxiv.org/ftp/arxiv/papers/1208/1208.0928.pdf (2012), each of which is incorporated herein by reference in its entirety.

A suitable error correction gadget may include syndrome extraction circuits implemented as part of the quantum processor and a decoder implemented as part of a classical processor. It is a consequence of the threshold theorem (see Gottesman, D.; arXiv: 0904.2557 (2009) that if the error rate of the physical components syndrome extraction circuits is below a fixed threshold (determined empirically and varying based on the QECC used), and the decoder is perfect, then the failure rate of the error correction gadget can be made arbitrarily small by increasing the code distance of the QECC. A perfect decoder is likely impossible in practice, and moreover the decoding problem becomes harder to solve as the code distance is increased.

### Neural Network Quantum Error Correction Decoder

The function approximator may be implemented in various configurations, such as function approximator embodiments disclosed herein. One example of such a function approximator may include a mapping from input vectors to output vectors, manifested as a logically computable function, and possibly having tunable parameters which determine the underlying mapping. By tuning the parameters through a process referred to as training described elsewhere herein, a function approximator can be fitted to a given training dataset of input-output pairs, thereby approximating the true function from which the training data is generated. Once trained, the function approximator mapping approximates the true function by matching its behavior on the training dataset.

One way for implementing a practical quantum error correction decoder is to construct decoders based on neural networks for solving the decoding problem as described by some examples of such decoders in an article entitled: “Deep neural decoders for near term fault-tolerant experiments” by Chamberland, C., Ronagh, P., arXiv: 1802.06441 (2018), htps://arxiv.org/abs/1802.06441) which is incorporated herein by reference in its entirety. Decoders based on neural networks replace the classical decoder by a function approximator of the true decoding function. The function approximator may be produced by pre-training a model on data generated in simulation or in a quantum experiment. The quantum error correction decoders based on Neural Networks may be referred to as neural decodes.

The neural network may have nodes with activation functions. The activation is implemented by an activation circuit which maps an input signal to an output signal. This mapping may be of different forms, but in general is mostly nonlinear. In implementations, certain nonlinearity is introduced into an activation circuit to the flow of the signal. In general, in the activation circuit the input which is in some cases the summation of all the signals from previous nodes weighted by the corresponding weights is mapped to an output signal which depends on the details of the activation circuit. This mapping in most cases is nonlinear in nature. Depending on the desired functionality the activation circuit may be as simple as a threshold activated circuit, where an output is produced only if the input is above a threshold. In other implementations, the activation circuit may implement a more complex mapping like ReLU (rectified linear activation function unit), clipped ReLU, leaky ReLU, offset ReLU, ELU (exponential linear activation unit), clipped ELU, Sigmoid, TanH, and other functions.

A recurrent neural network may be used for the function approximator of the decoder. A recurrent neural network is a natural approach to handling the time-sequenced nature of the syndrome measurements. A recurrent neural network maintains an internal state vector, which is initialized as some pre-determined vector. A single recurrence step may be implemented by passing this internal state vector along with an input vector through a first feedforward neural network layer which yields a new internal state vector for the next recurrent step. The extraction step may be performed by passing the internal state vector through a second feedforward layer which yields an output vector. One full pass of inference, using a data point containing N rounds of measurements on each syndrome qubit, includes N rounds of recurrence steps (each using one of the measurement sets) followed by a single extraction step.

The recurrent neural network model may have an architecture which is simple enough to build, but yet complex enough to fit the training data and thereby accurately mimic a quantum error correction decoder. Therefore, it may be implemented on hardware which can operate within the dilution refrigerator or another cryogenic environment, reducing latency time and potential errors in data transfer to and from the quantum processor, and uses much less processing time than a classical decoder.

### Distributed Decoding and Multi-Stage Decoding Approaches

As the code distance increases linearly, the syndrome space increases exponentially, requiring an equivalently larger training dataset to train the neural decoder. To mitigate this scalability issue of practical neural network quantum error correction decoders, a distributed way of decoding has been proposed (Savvas Varsamopoulos, Koen Bertels & Carmen G. Almudever, Decoding surface code with a distributed neural network based decoder, 2020). Distributed decoding approaches rely on division of the surface code into small regions so that the error syndrome space is limited. This way, there is no need for the decoder to explore the whole code syndrome space, but it's enough only to decode every small sub-tile and combine the information from all of them to update the error probabilities for larger tiles obtained by concatenation. In combination with this distributed approach, multiple decoder modules based on different techniques and with varying levels of complexity may be combined to optimize the performance of the decoding method, especially as the code distance increases. This is often referred to as multi-stage decoding. For example, in one implementation of the distributed decoding scheme, the decoding method combines a classical decoding module (or simple decoder or global decoder), which provides a naive decoding for the whole lattice, and a neural network decoding module, which predicts whether the obtained error syndrome is properly corrected by the simple decoder or not.

### Neural Network Training

The training of a neural network is the process of finding the appropriate values of the neural network's tunable parameters, such as weights of connections between neurons of different layers and biases, through a learning algorithm, so that the trained neural network model performs better at a specific task or ensemble of tasks than without the training process. Multiple learning algorithms exist, and the choice of learning algorithm may depend on the task or tasks to be performed by the neural network. In some embodiments, the learning algorithm comprises (1) initializing the neural network tunable parameters to random values or other predetermined initial values, (2) providing a training data set, which is a set of (x, y) pairs, where x is an input data point and y is an output data point, (3) for each instance in the data set, providing the input data x as input to the neural network, and obtaining an output data y′, computing the objective function, which depends on the output data y′ and the output data y from the training set instance and on the model's parameters, and updating the model's tunable parameters so as to optimize the objective function, (4) and repeating the previous step until the objective function reaches a desired threshold.

The training may be performed on a digital representation of the neural network model, which is often referred to as ex situ training, but it is also possible to perform the training directly on the application specific hardware which will be used for the inferences. This is referred as in situ training. The training may be performed using a finite set of simulated training data or real data extracted from a quantum error correction protocol performed on an actual quantum processor, which is referred to as offline training. Alternatively, training could be performed in real-time as new data becomes available from a quantum error correction protocol, which is referred to as online training.

### Digital Unit

A digital unit may comprise a digital circuit. The digital circuit may comprise an electronic circuit that uses signals that are limited to two discrete values, represented by 0 (for example low voltage or current) and 1 (for example high voltage or current). In such circuits, signals are processed through logic gate circuits based on the Boolean logic. The electronic components constituting the logic gate circuits include but are not limited to transistors, diodes, and passive components such as resistors, capacitors, etc.

The commonly used digital circuits use analog-to-digital converters (ADCs) and digital-to-analog converters (DACs) to interface with their environment, since external signals (sound, light, temperature, spatial displacement, electrical current, etc.) are often analog in nature.

The performance of ADCs/DACs depends amongst other factors on their clock frequency, which will determine the sampling rate or conversion time of the converter, and their resolution, or the number of bits representing an analog signal mapped to or from a digital signal, which determines the precision of the converter. However, there is often a trade-off between conversion rate and resolution in ADCs/DACs on integrated circuit chips. For example, a higher resolution ADC will typically necessitate a larger number of conversion steps, and thus lead to a lower sampling rate, or longer conversion time.

Examples of digital circuits comprise flip-flops, microprocessors, memories, graphical processing units (GPUs), central processing units (CPUs), field programmable gate arrays (FPGAs), digital application specific integrated circuits (ASIC), etc.

### Analog Unit

An analog unit may comprise an analog circuit. In contrast with digital circuits, analog circuits can process signals with values along a continuous spectrum and produce a proportional representation of an external signal (sound, light, temperature, spatial displacement, electrical current, etc.) as an electronic voltage or current. Elementary electronic components of the analog circuits include but are not limited to memristors, transistors, diodes, resistors, capacitors, inductors, etc., and more complex building blocks may include operational amplifier circuits, which can perform roles such as buffer, differential amplifier, integrator, comparator, etc. More complex building blocks may comprise an analog switched capacitor circuit, an analog sample and hold circuit, an analog passive delay line, etc.

The performance of analog circuits depends amongst other factors on the bandwidth, slew rates, noise level, and operating ranges of its components, such as transistors and operational amplifier circuits. Compared to digital representation of values, analog signals are typically more susceptible to corruption by noise, loss, or deformation.

### Complementary Metal-Oxide Semiconductor (CMOS)

Complementary metal-oxide-semiconductor (CMOS) is a monolithic fabrication process and style of circuit design based on p-type and n-type metal-oxide-semiconductor field-effect-transistors (MOSFET). This process may be used to build electronic components and circuits for digital and analog applications. The electronic components and circuits may be packaged in integrated circuits (IC), allowing the combination of a large quantity of components on a single small piece of semiconductor material, or in individual, discrete electronic components, that can be combined on a printed circuit board for example.

The digital and analog electronic components described elsewhere herein are often built using CMOS technology, especially in the case of integrated circuit implementations. However, components such as diodes, transistors, and more, may also be fabricated using other monolithic fabrication processes and circuit designs. These include but are not limited to bipolar junction transistor (BJT) technology, silicon-on-insulator (SOI), bipolar CMOS (BiCMOS), and other fabrication technologies for analog, digital, and mixed-signals (combined analog and digital circuits) applications.

### Memristors

A memristor is a two-terminal electrical component that relates charge and magnetic flux (L. O. Chua, “Memristor- the missing circuit element”, IEEE Transactions on Circuit Theory, 18, no. 5, pp. 507-519, 1971, D. B. Strukov, G. S. Snider, D. R. Stewart, and R. S. Williams, “The missing memristor found”, Nature, 453, no. 7191, pp. 80-83, 2008), which is incorporated herein by reference in its entirety. It may be used as a variable and reprogrammable resistor. It may take the role of a non-linear circuit element with a dynamic relationship between current and voltage and may also offer an approximately linear regime of operation between voltage and current within certain bounds. In the case of bipolar memristors, depending on the direction of the current flow through the device, the electrical resistance may increase or decrease. In the case of unipolar memristors, depending on the voltage amplitude applied to the device, the electrical resistance may increase or decrease. The device is non-volatile, meaning that it maintains the last resistance state it had when the current stopped.

Multiple physical implementations of memristors have been reported, including devices based on resistive switching mechanisms (Chua, L. (2019). Resistance Switching Memories are Memristors. In: Chua, L., Sirakoulis, G., Adamatzky, A. (eds) Handbook of Memristor Networks. Springer, Cham. https://doi.org/10.1007/978-3-319-76375-O_6) which is incorporated herein by reference in its entirety, such as thin film oxide resistive memory devices (Yang, J., Pickett, M., Li, X. et al. Memristive switching mechanism for metal/oxide/metal nanodevices. Nature Nanotech 3, 429-433 (2008). https://doi.org/10.1038/nnano.2008.160, Matthew D. Pickett, Dmitri B. Strukov, Julien L. Borghetti, J. Joshua Yang, Gregory S. Snider, Duncan R. Stewart, and R. Stanley Williams, “Switching dynamics in titanium dioxide memristive devices”, Journal of Applied Physics 106, 074508 (2009) https://doi.org/10.1063/1.3236506) which is incorporated herein by reference in its entirety. In this implementation, a thin oxide film is sandwiched between two electrodes. A large external voltage applied between the electrodes brings the device from an initially highly resistive state to a low resistance state, through an electroforming process. Following this non-reversible electroforming process, the resistance of the device may be set to intermediate values between a minimal low resistance state (also referred to as the high conductance state) and a maximal high resistance state (also referred to as the low conductance state), through the application of specific voltage signals to the electrodes.

Memristors may perform analog computation (M. Laiho and E. Lehtonen, Arithmetic operations within memristor-based analog memory, 2010 12th International Workshop on Cellular Nanoscale Networks and their Applications (CNNA 2010), Berkeley, CA, USA, 2010, pp. 1-4), which is incorporated herein by reference in its entirety, acting as a non-volatile tunable and reprogrammable resistor that modulates the voltage drop or the current level in a specific part of an electronic circuit. They may also be used as multi-level registers to store analog information in their resistance state.

Memristors may be arranged in a crossbar array configuration (US20200110985A₁) which is incorporated herein by reference in its entirety, to perform dot-product or vector-matrix multiplication operation (Fabien Alibart et al., 2012 Nanotechnology 23 075201, US20210326689A₁) which is incorporated herein by reference in its entirety, in an energy-efficient manner and with small delay (U.S. Pat. No. 10,541,026B2, U.S. Pat. No. 11,521,054B2) each of which is incorporated herein by reference in its entirety. The crossbar array is a configuration with inputs and outputs producing a 2D grid of m×n intersections.

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be used, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

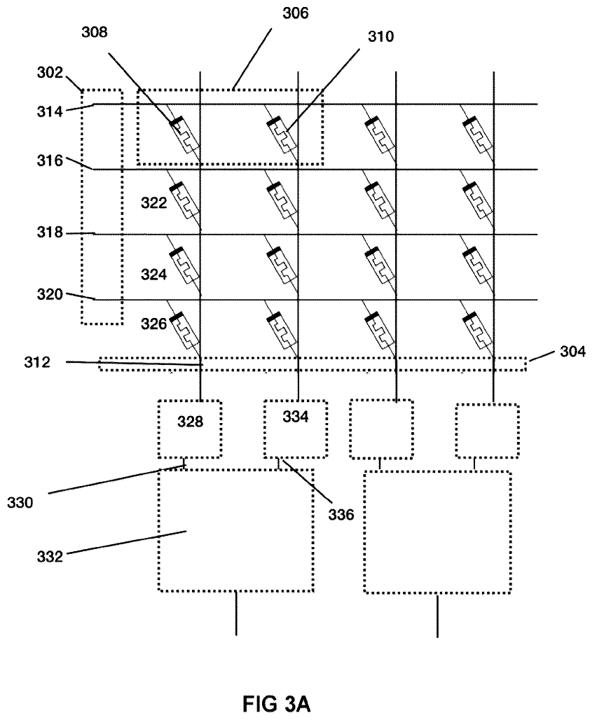

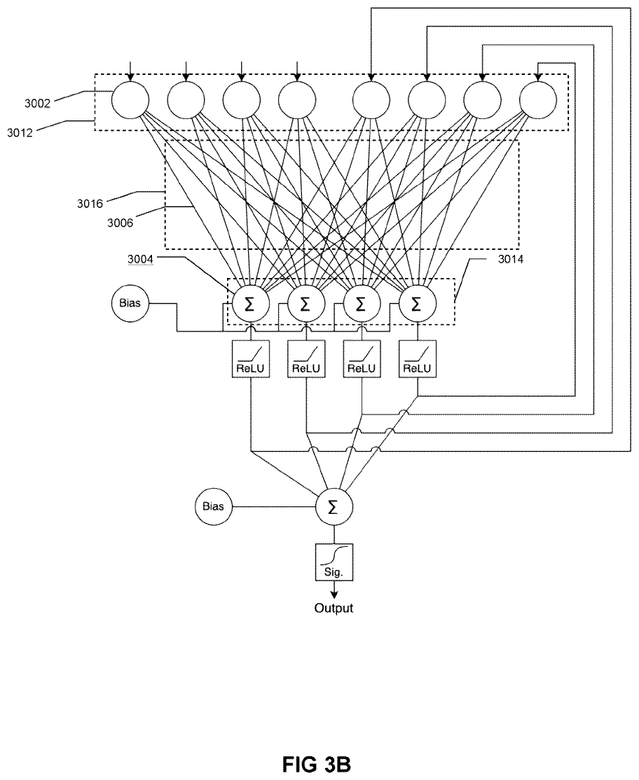

Now referring to FIG. 3A, there is shown a diagram of an embodiment of a memristor-based circuit for vector matrix multiplication. Herein, m is the number of input lines in the plurality of input lines 302 and n is the number of output lines in the plurality of output lines 304. Configurations in a 3D grid are also possible. The memristors are located at each intersection between input lines, referred to as word lines, and output lines, referred to as bit lines. The memristors share the same top electrode on a given row (word line), and the same bottom electrode on a given column (bit line).

Now referring to FIG. 3B, there is shown a diagram of a neural network architecture corresponding to the memristor-based circuit disclosed with respect to FIG. 3A. Herein, a first layer of neurons 3012 is connected to a second layer of neurons 3014 by a plurality of weights 3016. In the context of artificial neural networks, memristor crossbar arrays may be used to implement the matrix of weights between two layers and the biases of a neural network and compute the vector-matrix-multiplication operation used for the neural network inference process.

In some cases, each weight of a neural network is implemented by using a pair of memristors from the memristor crossbar array. For example, in one example, the pair of memristors 306, consisting of a memristor 308 with conductance state Gⱼₖ⁺ and a memristor 310 with conductance state Gⱼₖ⁻, implements weight Wⱼₖ, linking neuron j from one layer of the neural network and neuron k from another layer of the neural network. In one example, the pair of memristors 306 disclosed with respect to FIG. 3A implements weight 3006 linking neuron 3002 from neuron layer 3012 and neuron 3004 from neuron layer 3014 in the exemplary neural network disclosed with respect to FIG. 3B. The mapping between a weight Wⱼₖ and conductances Gⱼₖ^{±} is given by

$${G}_{jk}^{\pm } = \vert {W}_{jk} \vert \frac{{G}_{HCS} - {G}_{LCS}}{{W}_{max}} + {G}_{LCS} \qquad Eq . ( 1 )$$

wherein Wₘₐₓ is the absolute maximum weight of a given neural layer, G_{HCS} and G_{LCS} are the conductances in high and low conductance states of the memristors respectively, i.e., the maximum and minimum values that can be programmed on the memristor. If Wⱼₖ>0, Gⱼₖ⁺ is programmed with respect to Eq. (1) and Gⱼₖ⁻ is set to G_{LCS}. If Wⱼₖ>0, Gⱼₖ⁻ is programmed with respect to Eq. (1) and Gⱼₖ⁺ is set to G_{LCS}. This allows programming of positive and negative weights using positively-valued conductance states. Once the memristors in the crossbar array are programmed, the vector-matrix multiplication operation can be performed by sending input voltage signals to the input lines of the crossbar. Following Ohm's and Kirchoff's circuit laws, the output current of a given output line n^{±} is given by

$${I}_{n}^{\pm } = {\sum }_{m} {G}_{m , n}^{\pm } {V}_{m} , \qquad Eq . ( 2 )$$

wherein Iₙ^{±} is the current output of output line n^{±}, Vₘ is the input voltage at input line m, G_{m,n}^{±} is the conductance of the memristor at the intersection between input line m and output line n^{±}. In the example disclosed with respect to FIG. 3A, the current output at location 312 is given by the input voltage applied to input line 314 multiplied by the conductance of memristor 308, added to the input voltage applied to input line 316 multiplied by the conductance of memristor 322, added to the input voltage applied to input line 318 multiplied by the conductance of memristor 324, added to the input voltage applied to input line 320 multiplied by the conductance of memristor 326.

In some cases, current outputs of each output line are converted to voltage values with a transimpedance amplifier (TIA), where the output Vₙ^{±} of the TIA is a voltage proportional to the output line current:

$${V}_{n}^{\pm } = Γ {\sum }_{m} {G}_{m , n}^{\pm } {V}_{m} , \qquad Eq . ( 3 )$$

where Γ is the gain (amplification) of the TIA. A differential amplifier then takes as input in pin±the TIA output of line n^{±}, such that its output Vₙ is a voltage proportional to the sum of the input rows voltages multiplied by the effective conductance values of the differential pairs of memristors:

$${V}_{n} = γΓ {\sum }_{m} ( {G}_{m , n}^{+} - {G}_{m , n}^{-} ) {V}_{m} . \qquad Eq . ( 4 )$$

wherein γ is the gain (amplification) of the differential amplifier.

In the example disclosed with respect to FIG. 3A, the current output at location 312 is converted to a voltage by TIA 328. Then the output from TIA 328 is provided as input to pin 330 of differential amplifier 332, and the output from TIA 334 is provided as input to pin 336 of differential amplifier 332. Therefore, by mapping the weights of a neural network to differential pairs of memristors according to Eq. (1), memristor crossbar arrays may be used as part of a circuit to compute the forward-pass process corresponding to the vector-matrix multiplication process. The output of each pair of lines of the memristor crossbar array may be used as the input for an activation function circuit, wherein the output corresponds to the output of the neuron. In some cases, the current at the output of each memristor column is converted into an amplified voltage using a transimpedance amplifier and then the voltages arising from the positive and negative weights are subtracted using a differential amplifier in order to combine the positive and negative weights. In some cases of memristor-based circuits used for neural network implementations, the vector-matrix-multiplication may be obtained differently. In some cases, the two output currents may be directly subtracted for each pair of columns (positive and negative weights) using a current subtractor circuit (Current Mode Computational Circuits for Analog Signal Processing, Amanpreet Kaur and Rishikesh Pandey, IJAREEIE Vol. 3, Issue 4, April 2014), which is incorporated herein by reference in its entirety. Such a subtractor circuit may include two interconnected cascoded current mirror circuits, which may be designed to copy a current through one active device by controlling the current in another active device, keeping the output current constant regardless of loading.

In some cases of memristor-based circuits used for neural network implementations, it may be beneficial to separate the negative and positive weights into two distinct memristor crossbar arrays and feed voltages of opposite polarity to the negative weight crossbar. This may produce a negative current at the output of the negative weight crossbar and a positive current at the output of the positive weight crossbar. Thus, the combination of the negative weight dot product and positive dot product may be directly provided by the Kirchhoff's current law. In this implementation, the polarity of the voltage signal is flipped at specific stages of the circuit in order to switch the polarity of the voltage signal. This operation may be done using an inverter, which is a simple two-transistors circuit, implemented in an ASIC circuit.

### Hardware-Aware Training

Memristive devices may suffer from non-idealities that are known to deteriorate the analog computations' precision (Joshi, V. et al., Accurate deep neural network inference using computational phase-change memory, Nature Communications, 11, 2473, 2020) such as programming noise, cycle to-cycle variability, device-to-device variability, I/f read noise during the inference, drift of the conductance state in time, non-linearities of the current-voltage characteristics, and imperfect yield that translates into a certain probability that a memristor is stuck in the high or low conductance state following electroforming. These non-idealities may decrease the accuracy of an analog neural network with respect to its digital version since mapping from digital floating-point parameter to conductance is subject to errors and variation. However, hardware-aware training methods may improve computational training of analog neural decoders and lead to high accuracy convergence despite the non-idealities. In some cases of hardware-aware training, the neural network training is performed on a digital model (CPU, GPU, etc.), by incorporating specific hardware characteristics related to non-idealities. For example, memristors programming noise leads to an imperfect programming of the conductance state, and thus of the encoded parameter, since there is a variability in the resulting programmed conductance. This non-ideality may be taken into account during the training process. To take this non-ideality into account during the training process, the tunable parameters may be updated after each training instance to values that are sampled from a probability distribution around the ideal value calculated via the ideal training algorithm. In some cases, the probability distribution may correspond to the statistical variability associated with the memristor programming process. A similar training approach may be applied simultaneously to other non-idealities, so that the final trained neural network parameters are robust to variations caused by various non-idealities during the actual hardware inference process. The hardware-aware training may also be extended to non-idealities and hardware characteristics beyond memristor devices, such as digital or analog electronic circuits and components, including activation function circuits, DACs, and ADCs, and more.

### Activation Function Circuits

Activation function units implementing activation functions may be constructed using digital or analog electronic circuits, either through the combination of discrete electronic components on a printed circuit board or other platform, through design and fabrication of application-specific integrated circuits, or a combination of both. Field-programmable gate arrays (FPGAs) and classical processing units such as CPU or GPU may also be used to compute various activation functions. In some cases, the activation function may be implemented using an analog implementation of the Rectified Linear unit activation function. Main components of the analog activation function circuit may include resistors, diodes, operational amplifiers, and supply voltage sources (Fatemeh Kiani, Jun Yin, Zhongrui Wang, J. Joshua Yang and Qiangfei Xia, A fully hardware-based memristive multilayer neural network, Science Advances, vol. 7, 48, 2021), which is incorporated herein by reference in its entirety. In some cases, the implementations of the circuit may comprise custom integrated circuit implementations. For example, the transfer characteristic of specific devices such as multimodal transistors may replicate the ReLU activation function (Surekcigil Pesch, I., Bestelink, E., de Sagazan, O. et al. Multimodal transistors as ReLUI activation functions in physical neural network classifiers. Sci Rep 12, 670, 2022), which is incorporated herein by reference in its entirety. In some cases, an appropriate combination of transistors in an integrated circuit may also provide a ReLU-like response (K. Smagulova, O. Krestinskaya and A. James, Who is the Winner? Memristive-CMOS Hybrid Modules: CNN-LSTM Versus HTM, in IEEE Transactions on Biomedical Circuits and Systems, vol. 14, no. 2, pp. 164-172, 2020), which is incorporated herein by reference in its entirety. In some cases, the activation function may comprise the sigmoid function. Various analog circuit realizations of the sigmoid activation function may be used, relying on a combination of resistors, transistors, differential amplifiers, diodes, and voltage divider circuits (Xu S, Li X, Xie C, Chen H, Chen C, Song Z. A, High-Precision Implementation of the Sigmoid Activation Function for Computing-in-Memory Architecture, Micromachines. 2021; 12 (10): 1183), which is incorporated herein by reference in its entirety, resistors, operational amplifiers, and memristors (C. Yakopcic, M. Z. Alom and T. M. Taha, Memristor crossbar deep network implementation based on a Convolutional neural network, 2016 International Joint Conference on Neural Networks (IJCNN), Vancouver, BC, Canada, 2016, pp. 963-970), or a push-pull CMOS amplifier circuit (Gerardo Marcos Tornez Xavier, Felipe Gómez Castañeda, Luis Martin Flores Nava, José Antonio Moreno Cadenas, Memristive recurrent neural network, Neurocomputing, Volume 273, 2018, Pages 281-295), which is incorporated herein by reference in its entirety.

In some cases, another implementation may be used, combining transistors, Zener diode and memristor and setting appropriate supply voltages allows the realization of the sigmoid activation function or the hyperbolic tangent activation function (Smagulova, K., Krestinskaya, O. & James, A.P. A memristor-based long-short-term memory circuit, Analog Integr. Circ. Sig. Process. 95, 467-4, 72, 2018), which is incorporated herein by reference in its entirety. Another realization of either the sigmoid or hyperbolic tangent activation functions may be obtained through adjustment of the supply voltages, supply currents, and transistors' dimensions, in a circuit composed of transistors and differential amplifiers (K. Adam, K. Smagulova and A. P. James, Memristive LSTM network hardware architecture for time-series predictive modeling problems, 2018 IEEE Asia Pacific Conference on Circuits and Systems (APCCAS), Chengdu, China, 2018, pp. 459-462)), which is incorporated herein by reference in its entirety. Other circuits combining different transistors, differential amplifiers, resistors, and/or more complex circuit blocks may be used for implementing the hyperbolic tangent, hard hyperbolic tangent, or softmax activation functions (Krestinskaya, O., Choubey, B. & James, A. P., Memristive GAN in Analog, Sci Rep 10, 5838, 2020, O. Krestinskaya, K. N. Salama and A. P. James, Learning in Memristive Neural Network Architectures Using Analog Backpropagation Circuits, in IEEE Transactions on Circuits and Systems I: Regular Papers, vol. 66, no. 2, pp. 719-732, 2019, J. Shamsi, A. Amirsoleimani, S. Mirzakuchaki, A. Ahmade, S. Alirezaee and M. Ahmadi, Hyperbolic tangent passive resistive-type neuron, 2015 IEEE International Symposium on Circuits and Systems (ISCAS), Lisbon, Portugal, 2015, pp. 581-584, R. Zunino and P. Gastaldo, Analog implementation of the SoftMax function, 2002 IEEE International Symposium on Circuits and Systems. Proceedings, 2002, F. M. Shakiba and M. Zhou, Novel Analog Implementation of a Hyperbolic Tangent Neuron in Artificial Neural Networks, in IEEE Transactions on Industrial Electronics, vol. 68, no. 11, pp. 10856-10867, November 2021, S. Wang, K. M. Al-Tamimi, I. Hammad and K. El-Sankary, Towards Current-Mode Analog Implementation of Deep Neural Network Functions, 2022 20th IEEE Interregional NEWCAS Conference (NEWCAS), Quebec City, QC, Canada, 2022, pp. 322-326), each of which is incorporated herein by reference in its entirety.

Any combination of the approaches disclosed herein may also be used to implement an activation function circuit.

### Hardware Implementation of Recurrence

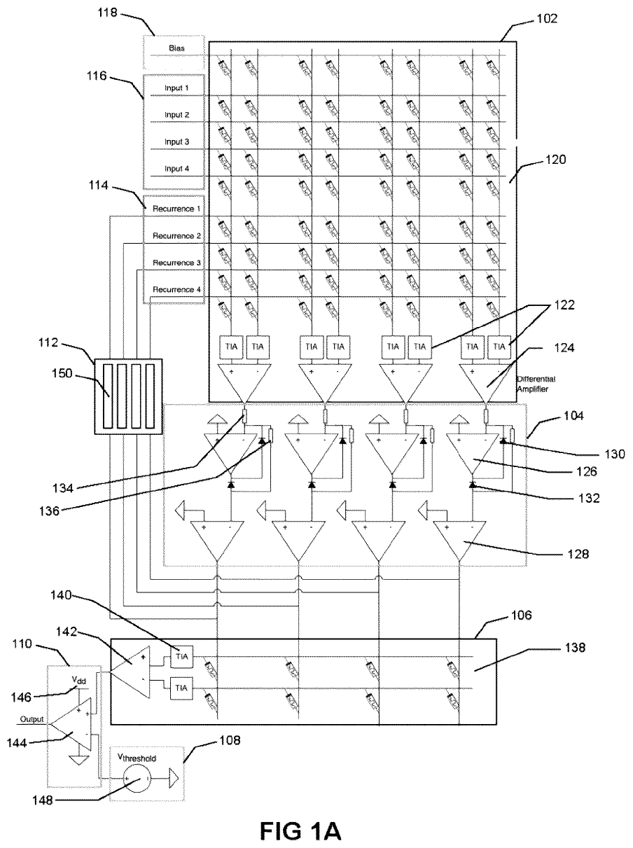

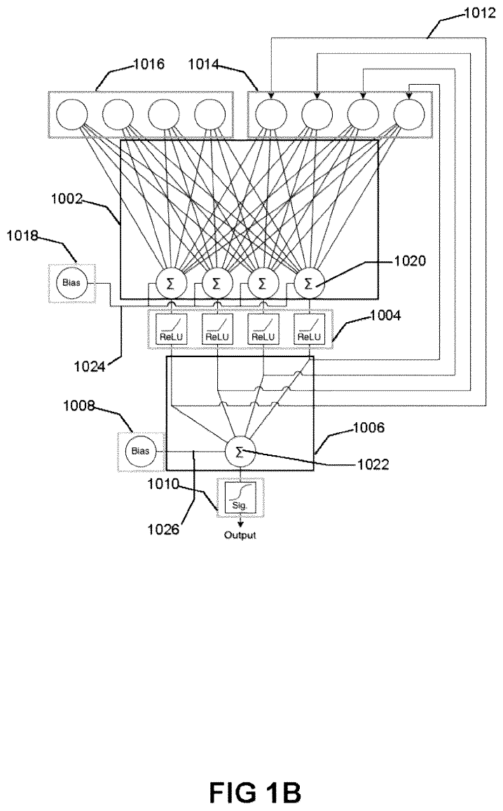

A hardware implementation of the recurrent neural network decoder may require a circuit dedicated to feeding back the internal state vector resulting from the forward-pass process at time step i to the internal state input stage of the circuit, and that is in synchronization with the arrival of the new input state vector, which is the syndrome measurement vector at time i+1. More specifically in the case disclosed with respect to FIG. 1A, the output of the activation function unit after processing of the input signals associated with syndrome i may be fed back to the hidden state input neurons and synchronized with the input signals associated with syndrome i+1. In some cases, in the digital domain, this process may be implemented by using an ADC to convert the activation function layer output signal from analog to digital value, and then storing it in a digital memory unit. The information may then be retrieved at the appropriate time with a trigger linked to the arrival of syndrome signals at time step i+1 and converted back to the analog domain by a DAC, sending the resulting signal to the corresponding hidden state neuron input at the same time as the syndrome from time step i+1 is sent to the input neurons. In some cases, the synchronization may be ensured by a digital managing block. In some cases, there is no need for a digital managing block, instead a digital delay line may be used. In some cases, the digital delay line may include shift registers. However, these digital methods may potentially be costly in terms of delay, power consumption, and complexity added by the signal conversions, and storing and retrieving, depending on the specificities of the circuit used. In some cases, an analog version of the switched capacitor circuit may be used instead (B. Hosticka, R. Brodersen, P. Gray, MOS Sampled Data Recursive Filters Using Switched Capacitor Integrators, IEEE Journal of Solid-State Circuits, Vol SC-12, No. 6, December 1977). In this case, the circuit capacitor samples the analog voltage it receives as input through a switch during the appropriate clock phase, and outputs this held sampled value through another switch after a chosen delay, which is determined by the choice of capacitance and resistance values in the circuit. Delays may be added if the forward-pass inference process is much faster than the time between successive syndrome arrivals. In other cases, recurrence may be implemented using an integrator circuit followed by a voltage amplifier, using operational amplifiers. The integrator may average the voltage at the output of the activation function unit for the duration corresponding to the remaining delay before the arrival of the next time step syndrome signal. Another analog approach for implementing the delay used for a synchronized recurrence process may be to use a lumped passive delay line, which is a low pass filter designed to delay (phase shift) the input signal by a specified increment of time and comprises series inductors and shunt capacitors with values dictated by the line impedance and the intended delay. In some cases, various combinations of these approaches may also be used to implement a recurrence circuit.

Disclosed herein a memristors-based circuit for implementing a quantum error correction decoder. The memristors-based circuit comprises a memristor crossbar unit. The memristor crossbar unit disclosed herein is configured to receive data of quantum measurements from a quantum error correction protocol and to implement a plurality of tunable parameters of a neural network.

Now referring to FIG. 1A, there is shown a diagram of an example of a memristors-based circuit for implementing a quantum error correction decoder. The quantum error correction decoder may comprise a neural network. The quantum error correction decoder implemented on a memristors-based circuit and comprising a neural network is generally referred to as “a memristors-based neural network quantum error correction decoder”.

The memristors-based circuit disclosed with respect to FIG. 1A for implementing a quantum error correction decoder comprises a first memristor crossbar unit 102, a first activation function unit 104, a second memristor crossbar unit 106, and a second activation function unit 110. The memristors-based circuit for implementing a quantum error correction decoder further comprises input ports 114, 116, and 118; a recurrence unit 112, and a threshold bias unit 108.

The first memristor crossbar unit 102 is configured to receive data of quantum measurements from a quantum error correction protocol via the input ports 116. Herein, quantum measurements generally refer to the readout results obtained by the syndrome extraction circuit. The readout results can either have logical value 0 or 1. In some cases, the data of quantum measurements may be provided as a voltage pulse signal of given amplitude and duration, with a specific amplitude assigned to the 0 or 1 logical value corresponding to the result of the quantum measurement. The first memristor crossbar unit 102 may be further configured to implement a plurality of weights of a neural network, such as the neural network disclosed with respect to FIG. 1B. In some cases, the first memristor crossbar unit 102 may comprise memristors array 120, transimpedance amplifiers (TIA) 122, and differential amplifiers 124. In this case, each weight of a neural network is implemented by using a pair of memristors from the memristor array 120, as disclosed herein with respect to Eq. (1). The first memristor crossbar unit 102 may be further configured to receive bias data via the input port 118. This bias data always has logical value 1, and the memristors on the row corresponding to the bias input data 118 may be used to implement the weights associated with the bias input. The output of each memristor array column may be a current pulse, which may be converted to a voltage pulse by the TIA 122. The voltage output of the two TIAs corresponding to paired column of memristors may then be subtracted via the differential amplifier 124.

In some cases, the first activation function unit 104 comprises operational amplifiers 126, differential amplifiers 128, diodes 130 and 132 and resistors 134 and 136. The first activation function unit 104 may be operatively coupled to the first memristor crossbar unit 102, such that the output of each differential amplifier 124 in the first crossbar unit 120 is fed into the corresponding activation function circuit of the first activation function unit 104. The first activation function unit 104 may be configured for implementing an activation function layer of the neural network, such as the neural network disclosed with respect to FIG. 1B. In some cases, the first activation function unit 104 may implement a ReLU function. In some cases, the implemented activation function may be a leaky ReLU, hard ReLU, exponential linear unit, softplus, sigmoid, hyperbolic tangent, hard hyperbolic tangent, softmax, threshold, a custom activation function, or a non-linear function.

In some cases, the first activation function unit 104 may be an analog unit. In some cases, the analog unit may comprise one or more members of the group consisting of resistor, capacitor, inductor, diode, operational amplifier, memristor, transistor, multi-modal transistor, discrete CMOS component, analog ASIC, or discrete components or ASIC from BJT, SOI, BiCMOS technologies or other monolithic fabrication technologies. In some cases, the first activation function unit 104 may be a digital unit. In some embodiments, the digital unit may comprise one or more members of the group consisting of a DAC, ADC, flip-flop circuit, microprocessor, memory, GPU, CPU, FPGA, digital ASIC, discrete CMOS component, or discrete components or ASIC from BJT, SOI, BICMOS technologies or other monolithic fabrication technologies.

Still referring to FIG. 1A, the second memristor crossbar unit 106 may be configured to receive data from first activation function unit 104 and may further be configured for implementing a plurality of weights of the neural network used for computing and providing results of the neural network, such as the neural network disclosed with respect to FIG. 1B. In some cases, the received data from first activation function unit 104 may be voltage pulses. The second memristor crossbar unit 106 may comprise memristors array 138, TIAs 140, and differential amplifier 142. In this case, each weight of a neural network may be implemented by using a pair of memristors from the memristor array 138, as disclosed herein with respect to Eq. (1).

The second activation function unit 110 may comprise an operational amplifier 144, and a supply voltage 146. The second activation function unit 110 may be operatively coupled to the second memristor crossbar unit 106, such that the output of differential amplifier 142 in the second crossbar unit 138 is fed into the associated input of the second activation function unit 110. In some cases, a threshold bias unit 108 may provide a threshold value to bias the activation function unit 110 output towards specific output values. The threshold bias unit 108 may consist of a voltage supply value 148.

The second activation function unit 110 may be configured for implementing an activation function output layer of the neural network, such as the neural network disclosed herein with respect to FIG. 1B. The second activation function unit 110 may implement a threshold function. In some cases, the implemented activation function is a ReLU, leaky ReLU, hard ReLU, exponential linear unit, softplus, sigmoid, hyperbolic tangent, hard hyperbolic tangent, softmax, a custom activation function, threshold, or a non-linear function.

In some cases, the second activation function unit 110 may be a digital unit. In some cases, the second activation function unit 110 may be an analog unit. In some cases, the analog unit may comprise one or more members of the group consisting of resistor, capacitor, inductor, diode, operational amplifier, memristor, transistor, multi-modal transistor, discrete CMOS component, analog ASIC, or discrete components or ASIC from BJT, SOI, BiCMOS technologies or other monolithic fabrication technologies. In some cases, the first activation function unit 104 may be a digital unit. In some cases, the digital unit may comprise one or more members of the group consisting of a DAC, ADC, flip-flop circuit, microprocessor, memory, GPU, CPU, FPGA, digital ASIC, discrete CMOS component, or discrete components or ASIC from BJT, SOI, BiCMOS technologies or other monolithic fabrication technologies.

Still referring to FIG. 1A, the recurrence unit 112 may comprise a recurrence circuit 150 for each recurrence line of recurrence input unit 114. The recurrence unit 112 may be coupled to the first memristor crossbar unit 102 and to the first activation function unit 104. The recurrence unit 112 may be configured for directing the first activation function unit 104 results to the first memristor crossbar unit 102 using input ports 114. In some cases, the recurrence circuit 150 may implement a delay in the data transfer between first activation function unit 104 results and input ports 114 so that the data arriving at input ports 114 is synchronized with the arrival of data of quantum measurements at input ports 116. In some cases, the recurrence circuit 150 may provide a mean to implement an appropriate delay with minimal loss of information of the data from first activation function unit 104 results. In some cases, the recurrence unit 112 may comprise one or more digital units. In some embodiments, the digital unit may comprise one or more members of the group consisting of a DAC, ADC, flip-flop circuit, microprocessor, memory, GPU, CPU, FPGA, digital ASIC, discrete CMOS component, or discrete components or ASIC from BJT, SOI, BiCMOS technologies or other monolithic fabrication technologies. In some cases, the recurrence unit 112 may comprise one or more analog unit. In some cases, the analog unit may comprise one or more members of the group consisting of resistor, capacitor, inductor, diode, operational amplifier, memristor, transistor, multi-modal transistor, discrete CMOS component, analog ASIC, or discrete components or ASIC from BJT, SOI, BiCMOS technologies or other monolithic fabrication technologies. In some cases, the recurrence unit 112 may include ADCs to convert the activation unit 104 output data from analog to digital domain, digital memory units to store the result of the conversion, trigger circuits to retrieve the stored data in synchronization with the arrival of data of quantum measurements at input ports 116, DACs to convert the retrieved data from digital to analog domain, and a digital managing block to manage the signals and timing. In some cases, the recurrence unit 112 may comprise a digital delay line, which may comprise shift registers. In some cases, the recurrence unit 112 may comprise an analog switched capacitor circuit. In some cases, the recurrence unit 112 may comprise one or more analog samples and hold circuits. In some cases, the recurrence unit 112 may comprise an integrator circuit and a voltage amplifier, which may comprise operational amplifiers. In some cases, the recurrence unit 112 may comprise a lumped elements passive delay line, which comprises inductors and capacitors.

Now referring to FIG. 1B, there is shown an example diagram of a neural network architecture corresponding to the quantum error correction decoder disclosed with respect to FIG. 1A. The neural network may comprise tunable parameters. The tunable parameters may be of various types, such as for example weights of connections between neurons of different layers and biases.

The neural network architecture corresponding to the quantum error correction decoder disclosed with respect to FIG. 1A may comprise input nodes 1016 and recurrent input nodes 1014, a first group of weights 1002, a first layer of output nodes 1020, a first activation layer 1004 for implementing a first activation function, bias nodes 1008 and 1018, a second group of weights 1006, a second layer of output nodes 1022, a second activation layer 1010 for implementing a second activation function, and recurrence connections 1012. The neural network may receive input data via input nodes 1014 and 1016 which correspond to the input ports 114 and 116 disclosed herein with respect to FIG. 1A. The weights from the first group of weights 1002 may be applied to the input data and the result for each node of first layer of output nodes 1020 may be computed, which corresponds to the computation performed by TIAs 122 and differential amplifiers 124 disclosed herein with respect to FIG. 1A. The output of each node in 1020 may then be provided to the first activation layer 1004. The first activation layer 1004 corresponds to and may be implemented on the first activation function unit 104 disclosed herein with respect to FIG. 1A. The weights from the first group of weights 1002 correspond to and may be implemented on the first memristor crossbar unit 102 disclosed herein with respect to FIG. 1A. A bias may be applied to the data using the bias node 1018 and corresponding set of weights 1024 between bias node 1018 and first layer of output nodes 1020. The bias node 1018 corresponds to and may be implemented on input port 118 disclosed herein with respect to FIG. 1A. The weights from the second group of weights 1006 may be applied to the data received from the first activation layer 1004 and the result for each node of second layer of output nodes 1022 may be computed, which corresponds to the computation performed by TIAs 140 and differential amplifiers 142 disclosed herein with respect to FIG. 1A. The output of each node in 1022 may then be provided to the second activation layer 1010. The second activation layer 1010 corresponds to and may be implemented on the second activation function unit 110 disclosed herein with respect to FIG. 1A. The weights from the second group of weights 1006 correspond to and may be implemented on the second memristor crossbar unit 106 disclosed herein with respect to FIG. 1A. A bias may be applied to the data using the bias node 1008 and corresponding set of weights 1026 between bias node 1008 and second layer of output nodes 1022. The bias node 1008 corresponds to and may be implemented on threshold bias unit 108 disclosed herein with respect to FIG. 1A.

The first and second activation functions 1004 and 1010 may comprise a non-linear function. The first and second activation functions 1004 and 1010 may comprise one or more members of the group consisting of: ReLU, leaky ReLU, exponential linear unit, softplus, sigmoid, hyperbolic tangent, softmax, threshold, hard ReLU, hard hyperbolic tangent, or custom activation functions.

In some cases, the memristors-based circuit disclosed herein may further comprise a preprocessing unit not shown in the figure for converting quantum measurements into input signals for the memristor crossbar unit. This preprocessing unit may take as input analog or digital data from quantum measurements and may produce as output analog or digital data with signal shape, amplitude, and length appropriate for appropriate processing of the data by the memristor-based circuit.

In some cases, the memristors-based circuit disclosed herein may further comprise a memory unit not shown in the figure to store the results of the inference on the memristor-based circuit. The memory unit may be used in the context of repeated QEC to store inference outputs from successive QEC rounds.

In some cases, the results of inference on the neural network implemented on the memristors-based circuit disclosed herein may be used for constructing at least one recovery operation for quantum error correction. This construction process may include taking as input the binary output of the neural network, converting it to an equivalent logical error affecting the logical qubit, and finding the recovery operation that may correct the logical state.

In some cases, the memristors-based circuit disclosed herein may further comprise a classical processing unit not shown in the figure for converting the at least one result of inference on the neural network to the at least one recovery operation for QEC.

In some cases, the memristors-based circuit disclosed herein may further comprise postprocessing unit not shown in the figure for converting the at least one recovery operation into control data for the quantum error correction protocol. The postprocessing unit may take as input the at least one recovery operation constructed from the memristor-based circuit output and convert it into a list of control operations for realizing the corresponding quantum error correction recovery operation.

In some cases, the memristors-based circuit disclosed herein may be part of a distributed decoding approach or may be used in ensemble with another decoding module within a multi-stage decoding architecture.

In some cases, the memristors-based circuit disclosed herein may be placed in a cryogenic device structured to include different cryogenic stages at different cryogenic temperatures, wherein the memristor-based circuit is coupled to and cooled by the cryogenic device, and a quantum processor is coupled to and cooled by the same cryogenic device at a desired cryogenic temperature for proper operations of the qudits, enabling for minimization of the communication lag (or time latency) between the quantum processor and the memristor-based circuit that implements the decoder. It will be appreciated that the information travels at the speed of electromagnetic wave in the medium which is a finite value. The reduction in the travelled distance between modules may reduce the communication lag.

In some implementations, the memristor-based circuit that implements the decoder may be separated from the quantum processor and may be kept in the cryogenic device at a cryogenic temperature higher than that of the quantum processor such as 100 mK, 600 mK, 3 K or 4 K. In other implementations, the memristor-based circuit that implements the decoder may be kept in the cryogenic device at the same cryogenic stage as the quantum processor and at the same cryogenic temperature (e.g., tens of mK). The cryogenic device may be of various types. In some cases, the cryogenic device may comprise a cryogenic platform capable of reaching the low temperature for operation of qudits. In some cases, the cryogenic device may comprise a dilution refrigerator system with different cryogenic stages at different temperatures. In some cases, the cryogenic device may comprise a cryocooler system. In some cases, the cryogenic device may comprise an adiabatic demagnetization refrigerator.

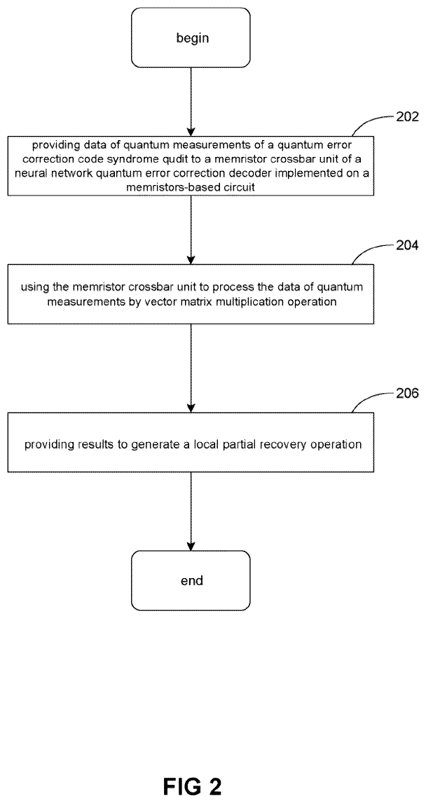

Now referring to FIG. 2, there is shown an example flowchart of a method for inference of a memristors-based quantum error correction decoder neural network.

According to processing operation 202, data of quantum measurements of a quantum error correction code syndrome qudits is provided to a memristor crossbar unit of a neural network quantum error correction decoder implemented on a memristors-based circuit. In some cases, the data of quantum measurements may be provided as a voltage pulse signal of a given amplitude and duration, with a specific amplitude assigned to the 0 or 1 logical value corresponding to the result of the quantum measurement for each element of the syndrome vector.

The memristor crossbar unit may be of various types such as the memristor crossbar unit disclosed herein with respect to FIG. 1A and FIG. 3A.

In some cases, bias data may be applied to the bias input port simultaneously to the data of quantum measurements being applied to the input ports. In some cases, the bias data may be provided as a voltage pulse signal of given amplitude and duration corresponding to the 1 logical value.

According to processing operation 204, the data of quantum measurements is processed by vector matrix multiplication operation using the memristor crossbar unit. The voltage pulse signals for each element of the syndrome vector may be provided to the corresponding input line of a memristor crossbar array of the memristor crossbar unit, and the current at each output line of the memristor crossbar array corresponds to the sum of the element-wise multiplication of the syndrome vector voltage pulses by the conductances of the memristor crossbar array column associated with the given output line.

In some cases, a first activation function may be applied to the processed data, such that the output of each activation function unit is proportional to the product of the input signal by the activation function. The results may then be directed to a second memristor crossbar unit of the neural network quantum error correction decoder to process the first activation function results by vector matrix multiplication. In some cases, a second activation function may be applied to the results of the second memristor crossbar unit.

In some cases, the results of the application of the first activation function to the processed data of quantum measurements are directed to the first memristor crossbar unit using a recurrence unit and processing operation 204 is repeated. The recurrence unit may be of various types such as the recurrence unit 112 disclosed herein with respect to FIG. 1A. In some cases, the same procedure may be repeated two or more times. In some cases, the procedure may be repeated d or more time, where d is the code distance. In some cases, the recurrence unit may comprise an ADC, a digital memory, a trigger, a DAC, and a digital managing block. In some cases, the recurrence unit may comprise a digital delay line. In some cases, the recurrence unit may comprise a switched capacitor circuit. In some cases, the recurrence unit may comprise an integrator circuit and a voltage amplifier. In some cases, the recurrence unit may include a lumped passive delay line. The recurrence unit may be of various types, such as any recurrence unit disclosed elsewhere herein with respect to FIG. 1A.

Still referring to FIG. 2 and according to processing operation 206, results are provided to generate a local partial recovery operation. In some cases, this may include providing the output of processing through the memristor-based circuit to a classical processing unit for constructing at least one recovery operation for quantum error correction. The construction process may comprise taking as input the binary output of the neural network quantum error correction decoder, converting it to an equivalent logical error affecting the logical qubit, and finding the recovery operation that may correct the logical state. In some cases, the at least one recovery operation may be converted to control data for the quantum error correction protocol by a classical postprocessing unit. The postprocessing unit may take as input the at least one recovery operation constructed from the memristor-based circuit output and convert it into a list of control operations for realizing the corresponding quantum error correction recovery operation.

Disclosed herein a method for training a memristors-based neural network quantum error correction decoder. The memristors-based neural network quantum error correction decoder may be of various types. The memristors-based neural network quantum error correction decoder may be such as the memristors-based neural network quantum error correction decoder disclosed with respect to FIG. 1A and FIG. 3A.

In some cases, the method may comprise implementing a digital representation of a quantum error correction decoder neural network on a digital platform and training said digital representation according to simulated or real data from quantum measurements of a quantum error correction code, which is referred to as ex situ training. In some cases, training may be performed directly on the quantum error correction decoder neural network hardware, using simulated or real data from quantum measurements of a quantum error correction code, which is referred to as in-situ training. In some cases, the method may comprise performing training using a finite set of simulated training data or real data extracted from a quantum error correction protocol performed on an actual quantum processor, which is referred to as “offline” training. In some cases, training may be performed in real-time as new data becomes available from a quantum error correction protocol, which is referred to as “online” training. In some cases, the training methods disclosed herein may be combined to perform a hybrid training ex situ/in situ and/or offline/online.

The training method may comprise at each training step amending a plurality of the neural network quantum error correction decoder tunable parameters based on characteristics of a memristor crossbar, so that the final values of tunable parameters of the trained neural network provide an inference output that is more robust to the characteristics of the memristor crossbar array that can influence the output of inference performed on the memristor-based circuit. In some cases, the training may be performed ex situ, on a digital representation of the neural network quantum error correction decoder implemented on a classical computer, so that amending a plurality of tunable parameters is achieved by modifying each tunable parameter's corresponding digital representation. In some cases, the training may be performed in situ, on a memristor-based circuit implementing the neural network quantum error correction decoder, so that amending a plurality of tunable parameters is achieved by reprogramming the equivalent memristor's conductance state to the amended value corresponding to the new tunable parameter's value for each tunable parameter. The characteristics may be obtained empirically. The characteristics of said memristor crossbar may be of various types. The characteristics of said memristor crossbar may comprise one or more of: programming error of the memristor conductance of said memristor crossbar, readout variability of the memristor conductance of said memristor crossbar, rate of stuck-at-fault memristors of said memristor crossbar, the conductance drift in time of the memristor conductance states, the minimal and maximal conductance value of each memristor, the resistance of the crossbar interconnections, and specific location of stuck-at-fault memristors within said memristor crossbar.

In some cases, the amending of the plurality of the quantum error correction decoder neural network tunable parameters may comprise adding a deviation sampled from a probability distribution corresponding to the programming and readout variability of the memristor conductance to the digital values of tunable parameters.

In some cases, the amending of the plurality of the quantum error correction decoder neural network tunable parameters may comprise for the tunable parameters corresponding to the stuck-at-fault memristors identified empirically updating the values to the stuck-at-fault memristors values. In some cases, the amending of the plurality of the quantum error correction decoder neural network tunable parameters may comprise updating random tunable parameters to the stuck-at-fault memristors values. In some cases, the updating of the random tunable parameters may be performed according to a probability corresponding to the empirically measured proportion of stuck-at-fault memristors in the memristor crossbar.

The training method may comprise at each training step amending the input data and/or the output data values to take into account other characteristics of the memristor-based circuit. The characteristics of the memristor-based circuit may include precision of digital-to-analog conversions performed on the input data, precision of analog-to-digital conversions performed on the output of the circuit, shape of the analog activation function, and deformation of the pulse signals through the CMOS components, such as the ones included in the activation function blocks or recurrence units.

The neural network architecture disclosed herein with respect to FIG. 1B corresponding to the memristor-based quantum error correction decoder disclosed with respect to FIG. 1A may be trained on a purely digital representation and the resulting optimized parameters may be mapped onto the quantum error correction decoder physical circuit disclosed with respect to FIG. 1A.

In some cases, prior to performing inference on the neural network quantum error correction decoder, the final tunable parameters values obtained from training the digital representation of the neural network quantum error correction decoder may be mapped to conductance states of the memristors in the memristor-based circuit. In some cases, each memristor of the memristor-based circuit may be programmed to the appropriate conductance state in accordance with the mapping to trained tunable parameters values of the neural network quantum error correction decoder.

The neural network architecture disclosed herein with respect to FIG. 1B may be modified to comprise more complex neural network architectures. The quantum error correction decoder disclosed with respect to FIG. 1A may be modified to implement more complex neural network architectures. In some cases, the more complex neural network architectures may comprise a larger number of recurrence inputs. In some cases, the more complex neural network architectures may comprise a larger number of neurons in each layer. In some cases, the more complex neural network architectures may comprise a larger number of layers. In some cases, the more complex neural network architectures may comprise various types of each layer connection (fully connected, convolution, skipped connections, long short-term memory, or any other). In some cases, the more complex neural network architectures may comprise the activation function having any other non-linear function. It may also be modified to process data from quantum measurements on larger code distance quantum error correction codes, such that the number of data input nodes is larger. The number of data input nodes may be 4, 5, 6, 7 or any other size so that the circuit can process codes of distance 3, 5, or more.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A memristors-based circuit for implementing a quantum error correction decoder, said circuit comprising a memristor crossbar unit configured for receiving data of quantum measurements from a quantum error correction protocol and for implementing a plurality of tunable parameters of a neural network.

2. The memristors-based circuit of claim 1, further comprising:
(a) a first activation function unit operatively coupled to said memristor crossbar unit, said first activation function unit is configured for implementing an activation function layer of said neural network;
(b) a second memristor crossbar unit operatively coupled to said first activation function unit, said second memristor crossbar unit configured for implementing a plurality of tunable parameters of said neural network; and
(c) a second activation function unit operatively coupled to said second memristor crossbar unit, said second activation function unit is configured for implementing an activation function output layer of said neural network.

3. The memristors-based circuit of claim 2, further comprising a recurrence unit operatively coupled to said memristor crossbar unit and to said first activation function unit, said recurrence unit is for directing said first activation function unit results to said memristor crossbar unit.

4. The memristors-based circuit of claim 3, wherein said recurrence unit comprises one or more digital units or one or more analog units;
further wherein said one or more digital units comprise at least one member of the group consisting of a flip-flop, a microprocessor, a digital memory, a graphical processing unit (GPU), a central processing unit (CPU), a field programmable gate array (FPGA), a digital application specific integrated circuits (digital ASIC), an analog-to-digital converter (ADC), a digital-to-analog converter (DAC), and a digital delay line; and said one or more analog units comprise at least one member of the group consisting of a memristor, an operational amplifier circuit, a diode, a transistor, a resistor, a capacitor, an inductor, an analog switched capacitor circuit, an analog sample and hold circuit, and an analog passive delay line, a multi-modal transistor, a discrete CMOS component, an analog ASIC, a discrete component or ASIC from BJT, SOI, BICMOS technologies.

5. The memristors-based circuit of claim 1, wherein results of inference on said neural network are used for constructing at least one recovery operation for quantum error correction.

6. The memristors-based circuit of claim 2 comprising two or more said memristor crossbar units and two or more said first activation function units.

7. The memristors-based circuit of claim 2 wherein said first and second activation function units comprise at least one member of the group consisting of: a non-linear function, ReLU, leaky ReLU, exponential linear unit, softplus, sigmoid, tanh, softmax, threshold, and hard ReLU.

8. The memristors-based circuit of claim 2, wherein at least one of said first and second activation function unit comprises a digital unit or an analog unit; further wherein said digital unit comprises at least one member of the group consisting of a flip-flop, a microprocessor, a digital memory, a graphical processing unit (GPU), a central processing unit (CPU), a field programmable gate array (FPGA), a digital application specific integrated circuit (digital ASIC), an analog-to-digital converter (ADC), a digital-to-analog converter (DAC), and a digital delay line; and
said analog unit comprises at least one member of the group consisting of a memristor, an operational amplifier circuit, a diode, a transistor, a resistor, a capacitor, an inductor, an analog switched capacitor circuit, an analog passive delay line, a multi-modal transistor, a discrete CMOS component, an analog ASIC, a discrete component or ASIC from BJT, SOI, BiCMOS technologies.

9. The memristors-based circuit of claim 1 further comprising at least one of:
(1) a preprocessing unit for converting quantum measurements into input signals for said memristor crossbar unit; and
(2) a postprocessing unit for converting results of inference on said neural network into control signals for said quantum error correction protocol.

10. The memristors-based circuit of claim 1, being used in ensemble with a global decoder within a multi-stage decoding architecture.

11. The memristors-based circuit of claim 1, coupled to a cryogenic device having different cryogenic stages.

12. A method for inference of a memristors-based quantum error correction decoder neural network, said method comprising:
(a) providing data of quantum measurements of a quantum error correction code syndrome qudits to a memristor crossbar unit of a quantum error correction decoder neural network implemented on a memristors-based circuit;
(b) using said memristor crossbar unit to process said data of quantum measurements by vector matrix multiplication operations;
(c) providing results to generate a local partial recovery operation.

13. The method of claim 12, further comprises prior to (c) (i) applying a first activation function to said processed data of quantum measurements; (ii) directing results to a second memristor crossbar unit of said quantum error correction decoder neural network; (iii) using said second memristor crossbar unit to process said results by vector matrix multiplication operations (iv) applying a second activation function to the output of said second memristor crossbar unit; further wherein the method comprises repeating (b) and (i) one or more times wherein the results of (i) are directed to said memristor crossbar unit using a recurrence unit.

14. The method of claim 12, wherein said quantum error correction code comprises one or more members of the group consisting of a stabilizer code, a topological code, a surface code, a rotated surface code, and a color code.

15. A method for training a memristors-based quantum error correction decoder neural network, said method comprising at each training step amending at least one tunable parameter of said quantum error correction decoder neural network based at least in part on characteristics of a memristor crossbar, which characteristics are obtained empirically.

16. The method of claim 15, wherein said characteristics of said memristor crossbar comprises at least one member of the group consisting of: programming error of the memristor conductance of said memristor crossbar, readout variability of the memristor conductance of said memristor crossbar, rate of stuck-at-fault memristors of said memristor crossbar, the conductance drift in time of the memristor conductance states, the minimal and maximal conductance value of each memristor, the resistance of the crossbar interconnections, and specific location of stuck-at-fault memristors within said memristor crossbar.

17. The method of claim 15, wherein said amending of said at least one tunable parameter of said quantum error correction decoder neural network comprises at least one of:
adding a deviation sampled from a probability distribution corresponding to the programming and readout variability of the memristor conductance to said at least one tunable parameter values for tunable parameters corresponding to the stuck-at-fault memristors identified empirically updating said tunable parameters to the stuck-at-fault memristors values; and
updating random tunable parameters to the stuck-at-fault memristors values.

18. The method of claim 17, wherein said updating said random tunable parameters is according to a probability corresponding to the empirically measured proportion of stuck-at-fault memristors in said memristor crossbar.

19. The method of claim 15, wherein said amending of said at least one tunable parameter of said quantum error correction decoder neural network takes into account characteristics of a corresponding memristor-based circuit, wherein said characteristics comprises at least one member of the group consisting of precision of digital-to-analog conversions, precision of analog-to-digital conversions, shape of the analog activation function, and deformation of the signals through the CMOS components.

20. A method for programming memristor crossbar of claim 1, said method comprising setting conductance state for each memristor in said memristor crossbar according to a corresponding trained tunable parameter.
